(19) United States
(12) Patent Application Publication
(10) Pub. No.: US 2015/0091874 A1
(43) Pub. Date: Apr. 2, 2015

(54) BUTTON SELECTION TRACE LIGHT INDICATOR

(71) Applicant: Continental Automotive Systems, Inc., Auburn Hills, MI (US)

(72) Inventors: Susan Adelle Drescher, Bloomfield Hils, MI (US); Robert Lee Drury, Rochester Hills, MI (US); Andreas Brueninghaus, Wiehl (DE); Alexander Klotz, Mountain View, CA (US); Arthur Stephen Brown, Sterling Heights, MI (US); Christian Andreas Schenkewitz, Singapore (DE); Robert John Hansen, Waterford, MI (US)

(21) Appl. No.: 14/495,364

(22) Filed: Sep. 24, 2014

Related U.S. Application Data
(60) Provisional application No. 61/884,285, filed on Sep. 30, 2013.

(51) Int. Cl. G06F 3/042

(52) U.S. Cl. CPC G06F 3/042
USPC 345/175

(57) ABSTRACT

A control display assembly includes a digital display for generating graphic features that represent vehicle system operating parameters and functions that are selectable by an operator. A plurality of buttons are spaced apart from the display and are associated with one of the graphic features generated by the display through a corresponding light path. The light path extends between one of the buttons and a corresponding graphic feature to provide a visual association between the button and the graphic feature generated by the display.

### CROSS REFERENCE TO RELATED APPLICATION

This application claims priority to U.S. Provisional Application No. 61/884,285 filed on Sep. 30 2013.

### BACKGROUND

Vehicle instrument panels are increasingly including digital displays to display graphics and to provide the control interface for many vehicle systems. The digital display generates graphic objects that are actuated with either fixed buttons (controlling one feature) or soft buttons on a touch sensitive display. The soft buttons can be changed as the features change on the screen, allowing for many different features to be controlled by one touch sensitive display. The use of fixed buttons are sometime desired when the digital display is spaced a distance from an operator. When a fixed button separate from a display is used to control a feature on a display, it may be unclear which button pairs with which feature on a display, or if there is any association at all.

Accordingly, vehicles that utilize reconfigurable buttons that are associated to a function on a display/screen are typically located directly next to the display so that the feature is physically located on the display next to the fixed button. However such a feature limits the location of the digital display as the associated buttons must be located within reach of a vehicle operator.

### SUMMARY

A disclosed control display assembly includes a digital display for generating graphic features that represent vehicle system operating parameters and functions that are selectable by an operator. A plurality of buttons are spaced apart from the display and are associated with one of the graphic features generated by the display through a corresponding light path. The light path extends between one of the buttons and a corresponding graphic feature to provide a visual association between the button and the graphic feature generated by the display. In an additional example, a trace is generated on the display that continues the visual association of the light path onto the display and to the graphic feature.

The light path and the trace provide a user with a visual association that identifies which of the button corresponds with actuation of a function represented by the graphic feature generated on the display. The light path visually links each of the fixed buttons to a corresponding graphic feature on the display thereby creating an easily understood link of the pairing of the graphic feature and the selected button. The visual link provided by the light path enables location of the fixed buttons closer to the user or driver while also enabling mounting of the display farther from the operator and closer to the user or driver's line of sight. Placement of the display closer to the driver's line of sight is desirable as it reduces off road glance times.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example vehicle instrument panel.

FIG. 2 is a schematic view of a vehicle console including a digital display.

FIG. 3 is a schematic cross-section of an example console.

FIG. 4 is a schematic cross-section of another example console.

FIG. 5 is a schematic view of another vehicle console.

### DETAILED DESCRIPTION

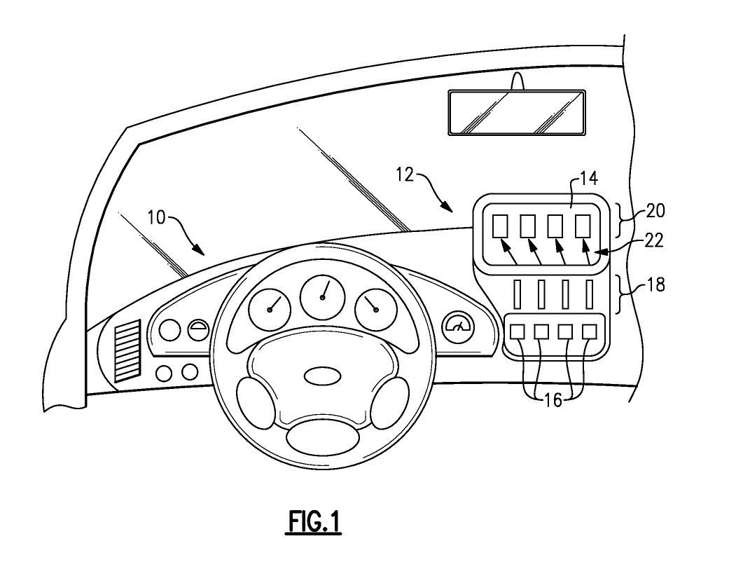

Referring to FIG. 1, a vehicle instrument panel 10 includes a center console 12 with a digital display 14 for generating graphic features 20 that represent vehicle system operating parameters and functions that are selectable by an operator. A plurality of buttons 16 are spaced apart from the display 14 and are associated with one of the graphic features 20 generated by the display 14 through a corresponding light path 18. The light paths 18 extend between one of the buttons 16 and a corresponding graphic feature 20 to provide a visual association between the button 16 and the graphic feature 20 generated by the display 14. In this example, a trace 22 is generated on the display 14 that continues the visual association of the light path 18 onto the display 14 and to the graphic feature 20.

The light path 18 and the trace 22 provide a user with a visual association that identifies which of the button 16 corresponds with actuation of a function represented by the graphic feature 20 generated on the display 14. The light path 18 visually links each of the fixed buttons 16 to a corresponding graphic feature 20 on the display 14 thereby creating an easily understood link of the pairing of the graphic feature 20 and the selected button 16. The visual link provided by the light path 18 enables location of the fixed buttons 16 closer to the user or driver while also enabling mounting of the display 14 in farther form the operator and closer to the user or driver's line of sight. Placement of the display 14 closer to the driver's line of sight is desirable as it reduces off road glance times.

Referring to FIG. 2, with continued reference to FIG. 1, the display 14 is located at a distance 38 from at least one of the buttons 16. It should be understood that the distance 38 illustrated is for disclosure purposes and will vary depending on application specific mounting requirements. Moreover, although a linear distance 38 is schematically indicated, the distance 38 may not be straight or in one plane, but could be spaced from the display in any number of configurations.

The example embodiment includes a plurality of buttons 16. The buttons 16 may be push buttons, cap sense buttons, IR buttons, but are not limited to those examples.

A controller 24 is associated with the buttons 16, the light guide 18 and the display 14 to provide an association between the buttons 16 and the graphic features 20 generated on the display 14. As the graphic features 20 change to facilitate actuation and monitoring of different vehicle systems, the controller 24 generates commands that associate each of the buttons 16 with a desired graphic feature 20. Moreover, the controller 24 manages the generation of the traces 22 generated on the display 14 between the light paths 18 and the corresponding graphic feature 20.

In the example, each of the plurality of buttons 16 has an associated light path 18. Each associated light path 18 extends to the display 14 from a point adjacent to its associated button 16. Generation of the graphic features 20 on the display 14 initiate illumination of the light path 18 and the trace 22 on the display to provide a visual display and indication that is easily recognized by a user of the association between one of the buttons 16 and the corresponding graphic feature 20. When one of the buttons 16 is activated, the corresponding light path 18 from a point adjacent the button 16 and extending to the display 14 can be activated to generate an additional illuminated display that confirms the association between the button 16 and the graphic feature 20. The illuminated display generated by the light path 18 can include sequentially illumination of lights along the path 18, flashing, and color changes along with any combination that provides a visual confirmation to a vehicle operator.

Referring to FIG. 3, the light path 18 includes a light source 26 that generates light that is communicated into a light guide 28. The light guide 28 directs light along the light path 18 between the button 16 and the display 14. The use of the light guide 28 enables the use of a single light source for each light path 18. The light sources 26 can be any lighting device such as a light emitting diode (LED) or a group of red, green and blue light emitting diodes to enable various color combinations.

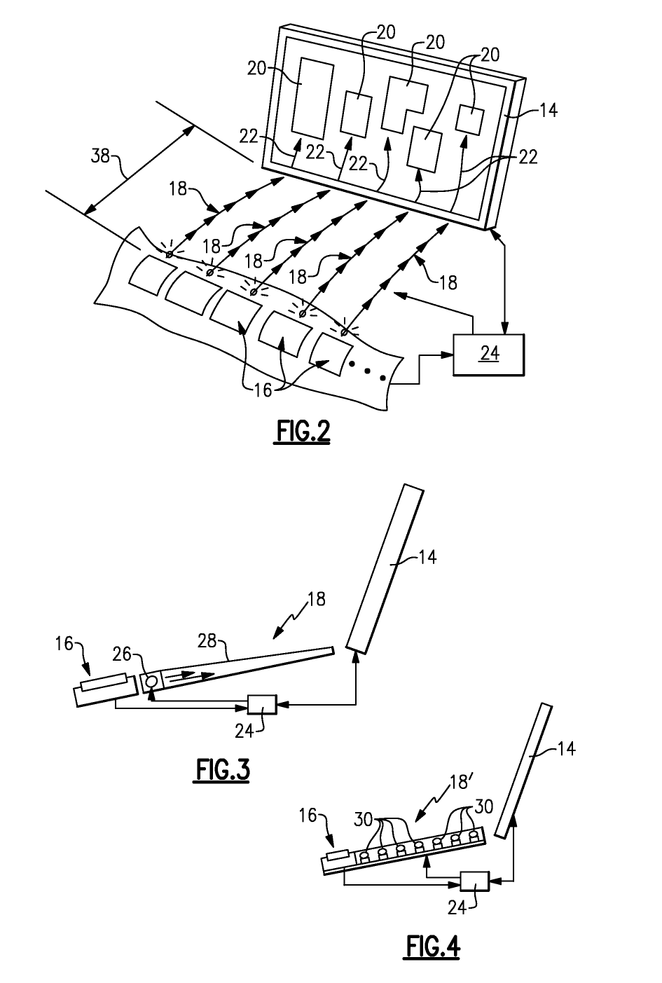

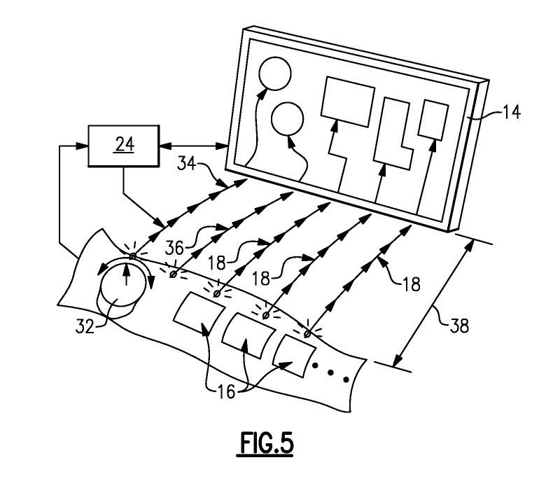

Referring to FIG. 4, another light path 18′ includes a plurality of light sources 30 arranged between the button 16 and the display 14. The light sources 30 can be any lighting device such as a light emitting diode (LED) or a group of red, green and blue light emitting diodes to enable various color combinations. The plurality of light sources 30 spaced apart along the light path 18′ enables illumination in desired sequences to create action displays that change responsive to actuation of a corresponding button 16, or when prompted by another desired input or triggering action. The plurality of light sources 30 may also be controlled to create lighting animation features to indicate direction, actuation or another feature coordinated by the controller 24 of systems within the vehicle. For example, when the button 16 is activated, the light path activates in sequence starting from button to display feature, and the feature changes in look to show activation.

Accordingly, operation of the console 12 can include associating the generated graphic feature for control of a desired function on the display 14. The controller 24 than provides for the association of one of the buttons 16 or other fixed input device with the graphic features 20. The light path is then illuminated between the fixed input device and the display to visually indicate the association between the fixed input device and the image generated on the display.

The illumination can include illumination of the light path 18 in a first manner prior to actuation of the input device such as for example a steady illumination. This could follow with an illumination of the light path in a second manner different than the first manner responsive to actuation of the input device to provide visual feedback and confirmation of actuation of a function represented by the generated image. The second manner could be a lighting animation including flashing of lights, or a sequence of lights that point between the buttons 16 and the display 14. The lighting animation could also include other animation sequences.

Referring to FIG. 5, with reference to FIG. 2, in the example shown in FIG. 2, each button 16 is associated with a single light path 18. However, other embodiments could include at least one of the buttons not having an associated light path or at least one of the buttons having a plurality of associated light paths. FIG. 5 illustrates an example console 12′ that includes a dial 32 in addition to the buttons 16. The dial 32 is rotatable to select between a first light path 34 and a second light path 36. The dial 32 therefore provides for actuation of more than one graphic feature. Rotation of the dial 32 to one of the first and second light paths 34, 36 can be visually indicated by a desired lighting animation.

The disclosed center console 12 enables placement and mounting of button 16 away from the associated display 14. With the example console 12, the buttons 16, no longer need be physically located next to the display 14. The combination of the light path 18 and the trace 22 enable the buttons 16 to be located a distance away from the display 14. The display 14 may be located in the driver's line of sight, while the reconfigurable buttons 16 are located close to the driver's reach distance. The console 12 also enables the use of fewer buttons 16 to operate an unlimited number of features that are represented by the digital display 14.

Accordingly, the light path 18 provides an association between generated graphic features on a display with fixed buttons spaced apart from the display. Moreover, the example console 12 enables the amount of fixed buttons to be minimized while changing the display 14 to show their various functions.

As one of ordinary skill would recognize, this disclosure is not limited to an automotive application. Rather, this disclosure relates to any application of buttons and display screens.

What is claimed is:

1. A control display assembly comprising:
a display configured to generate images indicative of a vehicle function;
at least one button disposed a distance from said display; and
a light path extending between the at least one button and the display, wherein the light path is configured to activate when the button is activated.

2. The display assembly as recited in claim 1, wherein the light path extends to a feature on the display, the feature associated with the at least one button.

3. The display assembly as recited in claim 2, wherein the display is configured to generate an image corresponding with the light path and actuation of the at least one button corresponds with actuation of a vehicle function represented by the generated image.

4. The display assembly as recited in claim 1, wherein the light path comprises a plurality of individual light sources oriented between the at least one button and the display.

5. The display assembly as recited in claim 1, wherein the light path comprises a light source and a light guide illuminable by the light source.

6. The display assembly as recited in claim 1, wherein the at least one button comprises a plurality of buttons and a corresponding plurality of light paths illuminable to associate at least some of the plurality of buttons with images generated on the display.

7. The display assembly as recited in claim 6, wherein the display is configured to generate different images for each of the plurality of buttons for different vehicle systems.

8. The display assembly as recited in claim 6, wherein the display is configured to generate a trace between the light path and the image generated on the display to associate one of the plurality of light paths with the generated image.

9. The display assembly as recited in claim 1, wherein actuation of the at least one button initiates actuation of the function represented by the image generated on the display.

10. The display assembly as recited in claim 1, wherein activation of the light path responsive to actuation of the at least one button comprises a sequence of illumination that includes a change in the generated image to indicate actuation.

11. A vehicle control assembly comprising:
a display configured to generate images indicative of a vehicle function;
a plurality of buttons spaced apart from the display; and
a plurality of light paths extending between each of the plurality of buttons and images generated on the display, wherein the light paths are illuminable to associate the plurality of buttons with a corresponding image generated on the display, wherein the button associated with the generated image activates the function represented by the image generated on the display.

12. The control assembly as recited in claim 11, wherein the light path comprises a plurality of individual light sources oriented between at least one of the plurality of buttons and the display.

13. The control assembly as recited in claim 11, wherein the light path comprises a light source and a light guide illuminable by the light source.

14. The control assembly as recited in claim 11, wherein the display is configured to generate a trace between the light path and the image generated on the display to associate one of the plurality of light paths with the generated image.

15. The control assembly as recited in claim 11, wherein activation of at least one of the plurality of light paths comprises a sequence of illumination that includes a change in the generated image to indicate actuation.

16. A method of associating control features with desired functions comprising:
generating at least on image on a display indicative of a function;
associating a fixed input device spaced a distance from the display with the image generated on the display; and
illuminating a light path extending between the fixed input device and the display to visually indicate the association between the fixed input device and the image generated on the display.

17. The method as recited in claim 16, wherein illuminating the light path comprises illuminating the light path in a first manner prior to actuation of the input device and illuminating the light path in a second manner different than the first manner responsive to actuation of the input device to provide visual feedback and confirmation of actuation of a function represented by the generated image.

18. The method as recited in claim 17, wherein at least one of the first manner and the second manner comprises a lighting animation.
